(19) United States
(12) Patent Application Publication
(10) Pub. No.: US 2005/0111945 A1
(43) Pub. Date: May 26, 2005

(54) Truck bed carrier

(76) Inventor: Robert Miller, Huntington Beach, CA (US)

Correspondence Address: I. Michael Bak-Boychuk;Attorney at Law, P.O. Box 32501, Long Beach, CA, 90832, US

(21) Appl. No.: 10/722,301

(22) Filed: Nov. 25, 2003

(51) Int. Cl. B60P 1/64

(52) U.S. Cl. 414/500

(57) ABSTRACT

A truck bed mounted carrier assembly is articulated by a powered pulley taking in or extending a belt to extend on an incline towards ground from the rear of the bed a ramp on which a dolly is translated. The dolly selectively engaged to the end of the belt includes a ribbed cage supporting a watercraft and the combined center of gravity of the dolly and the craft are used to pivot the ramp to an incline once it reaches the limit of its extension. The dolly is then disengaged from the belt for use in launching and recovering the craft.

### BACKGROUND OF THE INVENTION

1. Field of the Invention

The present invention relates to truck bed carriers, and more particularly to articulated carriers that are also useful as transporting dollies for launching personal watercraft.

2. Description of the Prior Art

Those who live at some distances from navigable waters often engage in towing or transporting their watercraft to the water's edge where the craft is then carried from the truck bed or, if towed, the towed trailer is then submerged into the water to float off the watercraft carried thereon. Of course, the trailer used in these applications requires wheel hubs that are both useful at highway speeds and also when submerged, with the corrosive aspects of salt water providing particularly severe conditions of use. The wheel bearings of the ubiquitous boat trailer are therefore constantly checked and greased and even periodically inspected along the side of the highway in the course of transporting a boat.

Recently the size of pleasure watercraft has reduced substantially with the advent of personal craft like that sold under the mark or style ‘Jet Ski’ by Kawasaki Motors, USA, or those sold under the mark or style ‘SeaDoo’ by Bombardier, which are often transported directly on the truck bed similar to the earlier practice of transporting motorcycles. While the prior art includes reference to transport dollies for the motorcycle, like that in U.S. Pat. No. 5,609,461 to Lichtenberg, such are mainly to accommodate repair and servicing and clearly not as a transport device for a transported personal watercraft.

In my prior U.S. Pat. No. 4,932,829 issued on Jun. 12, 1990 I have described an articulated motorcycle carrier which is particularly useful in lifting a motorcycle onto and off a truck bed. Since that time I have discovered that the foregoing carrier can be modified to cooperate with a watercraft supporting dolly in a manner that also assists the lifting stroke and it is this combination that I now disclose.

### SUMMARY OF THE INVENTION

Accordingly, it is the general purpose and object of the present invention to modify the motorcycle carrier structure of the '829 patent to adapt same for use with a wheeled carrier dolly conformed to support a personal watercraft.

Other objects of the invention are to provide an over-center incline in a pivoted carrier structure for controlling the descent of a watercraft transport dolly supported thereon.

Yet further objects of the invention are to provide a transport dolly useful in transporting a watercraft into the water and to lift same onto an articulated truck bed mounted carrier structure.

Briefly, these and other objects are accomplished within the present invention by providing an inclined edge height reduction in the telescoping portion of an articulated carrier structure like that shown in U.S. Pat. No. 4,932,829, and particularly FIGS. 8 through 11 thereof, onto which the front wheels of a dolly may be removed once the structure is deployed. Preferably this telescoping portion is received in the interior of a truck bed mounted track and is spring urged for extension against a belt that is reeled in by a motorized take up mechanism. In this manner the user of the carrier structure can control the extension of the telescoping portion beyond the bed edge which at a particular extension point becomes unbalanced to pivot the carrier assembly from the bed, thus lowering the rear end of the dolly towards ground. The dolly, and the watercraft mounted thereon, may then be lowered further to a point where the dolly is separated from the carrier to serve as a wheeled support in the course of floating the craft that is bedded thereon. Thus the elevated center of gravity of the dolly/watercraft combination is rendered useful both to fix the combination for transport and thereafter upon release to unbalance the carrier into its deployment form.

In this manner the wheels of the dolly are useful only in the course of its manipulation while floating or retrieving the watercraft. Moreover, specially formed supports and rollers may be installed on the dolly to accommodate the particular watercraft, thus insuring the otherwise more general utility of the remaining carrier structure. Of course, when not used for transport the dolly obtains further use as a convenient structure on which the watercraft may be stored.

### BRIEF DESCRIPTION OF THE DRAWINGS

FIG. 1 is a side view of a prior art motorcycle carrier installed on a truck bed and articulated to accommodate the loading and unloading of a motorcycle;

FIG. 2 is a diagrammatic illustration of the prior art motorcycle carrier shown in FIG. 1 in the course of articulation thereof,

FIG. 3 is a perspective illustration, separated by parts, of the prior art carrier assembly inventively modified to load and unload a watercraft from a truck bed;

FIGS. 4a, 4b and 4c are diagrammatic illustrations of the modified carrier shown in FIG. 3 in several stages of the articulation thereof,

FIG. 5 is a perspective illustration of an inventive watercraft carrying dolly in accordance with the present invention; and

FIGS. 6a and 6b are diagrammatic illustrations of the dolly shown in FIG. 5 in the course of launching the watercraft.

### DESCRIPTION OF THE PREFERRED EMBODIMENT

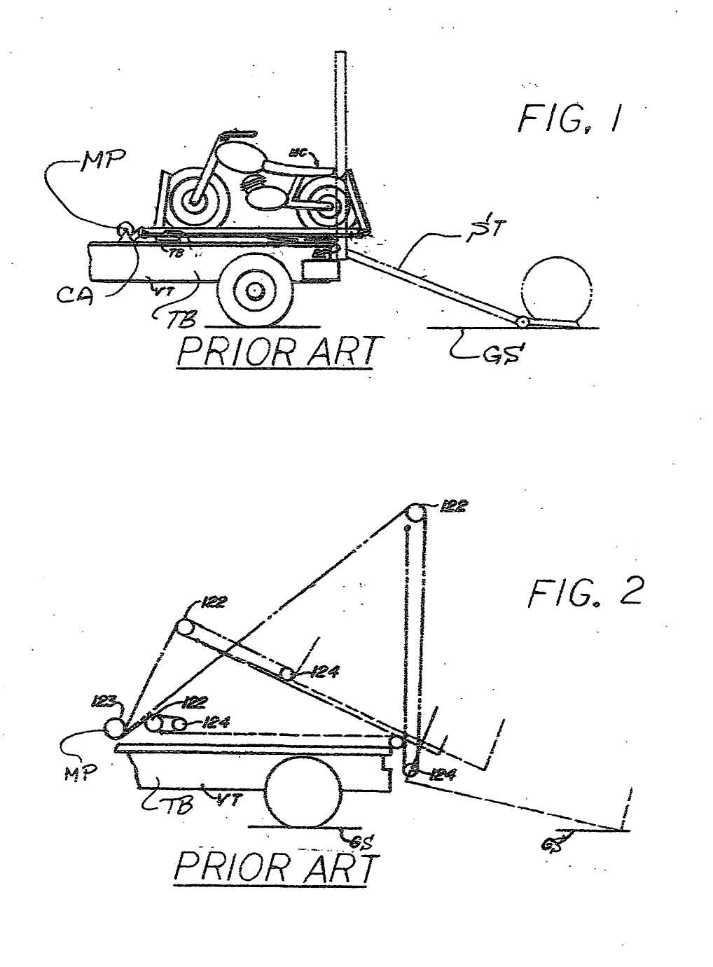

The present invention takes benefit and incorporates by reference the teachings earlier set out by me in U.S. Pat. No. 4,932,829, and in particular to the teachings illustrated in FIGS. 8 and 9 thereof, said illustrations being generally repeated herein as FIGS. 1 and 2, as further taught in the commercially vended article sold under the mark PAK-RAK by the RMX Corp., Huntington Beach, Calif. 92648. In this prior art arrangement a truck bed TB pivotally supports a carrier assembly CA including a sliding track ST on which a motorcycle MC is mounted. Once the combined center of gravity CG of the track ST and the motorcycle is moved by a spring past the pivot the deployment of the carrier assembly CA is then controlled by the extension of a belt B from a powered pulley MP. While this operative arrangement is particularly suitable for lowering the wheels of the motorcycle MC onto the ground GS, the soft hull panels of a personal watercraft lack the necessary structure. Moreover, the thickness of the hull and the shape thereof needed for upright stability preclude mounting the hull directly onto a narrow base. Both these aspects are uniquely accommodated in the novel structure set out below.

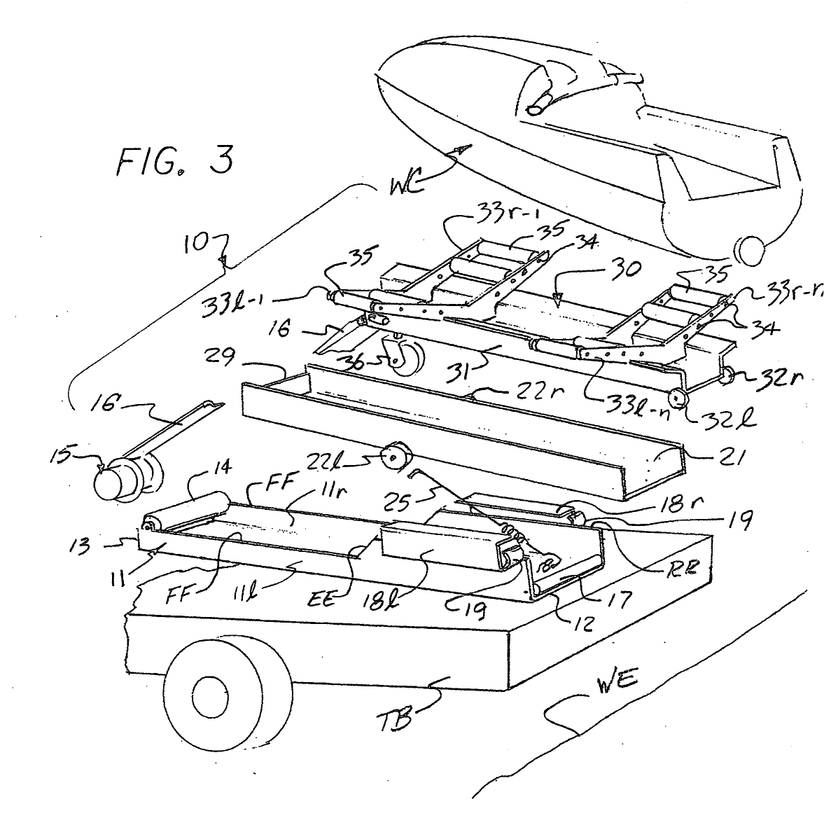

As shown in FIGS. 3 through 6b the inventively modified carrier assembly, generally designated by the numeral 10, includes a U-sectioned base channel piece 11 mounted longitudinally on the truck bed TB and aligned to extend the rear end 12 thereof over the rear edge RE of the bed. At the forward end 13 channel piece 11 is provided with a roller 14 spanning across the lateral side walls 11l and 11r forming the channel piece and aligned adjacent a bed mounted, electrically powered reversible winch 15 deploying and reeling in a flexible belt 16. The vertical dimension of walls 11l and 11r, moreover, are each expanded across an inclined edge to an increased height segment 11li and 11ri adjacent the rear end 12, the parallel edges thus forming a forward horizontal part FF and a rear horizontal part RR joined by inclined parallel edges EE. A further end roller 17 is then deployed between segments 11li and 11ri adjacent the rear end 12.

A conforming U-sectioned rail piece 21 is then received within channel piece 11, suspended between the side walls 11l and 11r on a pair of generally centrally disposed opposing exterior rollers 22l and 22r riding on the edge portions FF, EE and RR to support in rolling suspension the rail piece as it is advanced from roller 14 onto roller 17 in its travel within channel piece 11. A spring 25 connected tension between the channel piece 11 and rail 21 is then useful to urge rail 21 rearwardly off its support on roller 14 as belt 16 is reeled out while a set of opposed slots 18l and 18r each along a corresponding one of the rear edges RR captures rollers 22l and 22r to fix the pivotal motion of the rear end of rail 21 around the rear roller 17.

A dolly base piece 31 once again formed as a channel section is then received within rail 21 and supported for translation therein by a pair of rollers 32l and 32r. Base piece 31 forms the central spine of a cradle assembly defined by a plurality of transverse ribs 331-1 through 331-n cantilevered from the corresponding channel edge surface in opposition with similarly cantilevered ribs 33r-1 through 33r-n. Each of the ribs includes plural perforations 34 along the respective lengths thereof for selective mounting of rollers 35 in conforming supporting alignment of the watercraft WC. The forward end of base piece 31 is then releasably engaged to the free end of belt 16, thus forming a conveniently adaptable supporting dolly 30 that is cooperatively useful with the truck bed mounted carrier assembly. A removable forward roller 36 is then insertable into a mating fitting 37 formed in the forward end of base piece 31 right prior to the disengagement of belt 16 thus providing a wheeled assembly on which the watercraft WC is carried into the water. Of course, retrieval of the watercraft is similarly effected by simply reversing this sequence.

Those skilled in the art will appreciate that once these deployment and retraction sequences are initiated the general alignment of the rail and the base piece will result in a rearward weight bias which will result in an inclined alignment of the rear dolly end towards ground, To urge the rail towards a more horizontal inclination the set of opposed slots 18l and 18r are attached each along the corresponding one of edges RR to capture the exteriorly directed opposed rollers 22l and 22r therein and to limit the rearward translation thereof against corresponding end stops 19 in each slot. The retraction translation limit, in turn, is formed by an end stop 29 spanning across the forward end of rail 21 to oppose any further forward movement of the base piece 31 within the rail. Of course, at this forward limit the combined center of gravity CCG of the rail 21 and dolly 30, both with and without the watercraft WC thereon, effectively places the moving parts of the assembly within the interior of channel piece 11. At the other extreme the roller capture and translation limit within the opposed slots effectively cooperates with the shift in the center of gravity of the rail and the dolly assembly as the rail is and the dolly assembly are translated over the rear roller 17. In this manner a deployment and retrieval arc is assured accommodating various configurations of the rear edge of the truck bed TB.

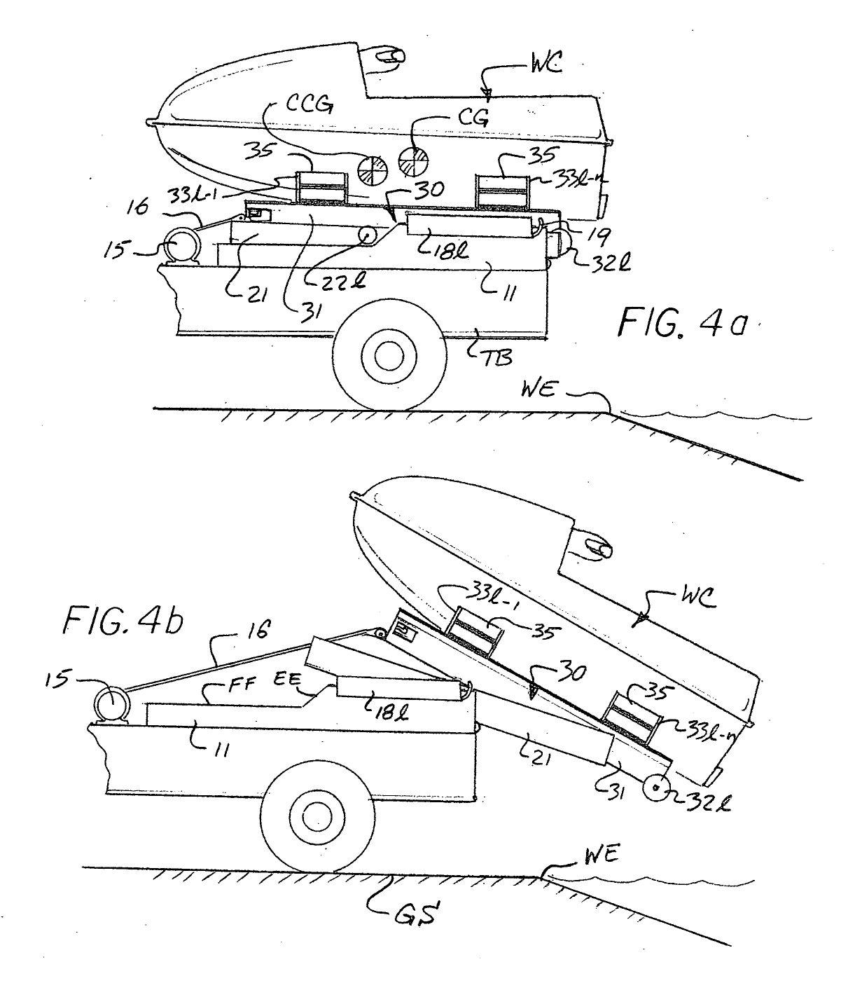

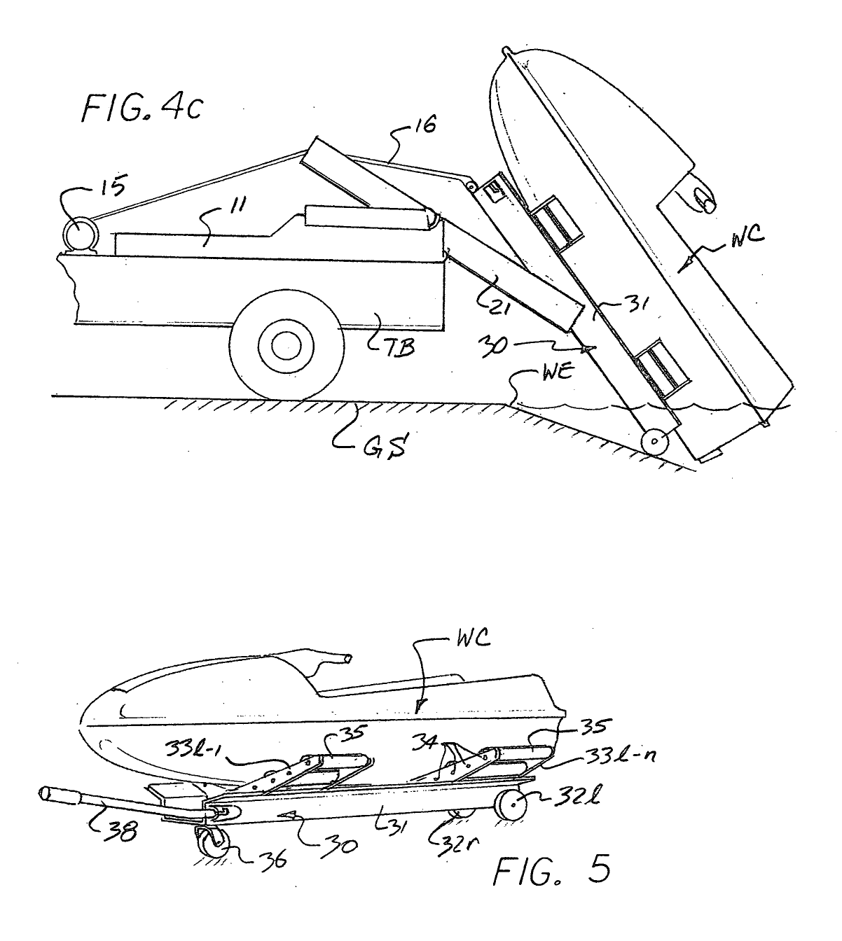

By particular reference to the sequence illustrated in FIGS. 4a, 4b and 4c the unloading process commences upon the spooling out of belt 16 from the motorized pulley 14 which then allows the translation of rail 21 outward as urged by the tension of the extended spring 25. Preferably the combined center of gravity CCG of the moving parts of the carrier and the watercraft WC is then generally above the rollers 22l and 22r. This translation continues generally horizontally with the rollers 22l and 22r then riding on the forward edge portions FF of the side walls 11l and 11r until the inclined edge segments EE are encountered at which point the upward displacement of the rollers together with the moment arm to the center of gravity CCG then tilting the carrier assembly as the tension of spring 25 is fully released. As the rollers reach their respective stops 19 the tilt and the generally high moment arm to the center of gravity CG of the watercraft-dolly combination then acts to pivot the rail 21 even further to a point where the dolly 30, tethered to belt 16, separates from its forward position against stop 29 beginning its slide out of rail 21. Once the rear dolly wheels 32l and 32r contact the ground surface GS the forward wheel 36 may be inserted into its fitting in base piece 31 and the further spooling out of belt 16 then lowers the loaded dolly assembly fully onto the ground surface. In this manner the somewhat greater center of gravity height of a watercraft sitting on its cradle is used to advantage to assist in its deployment.

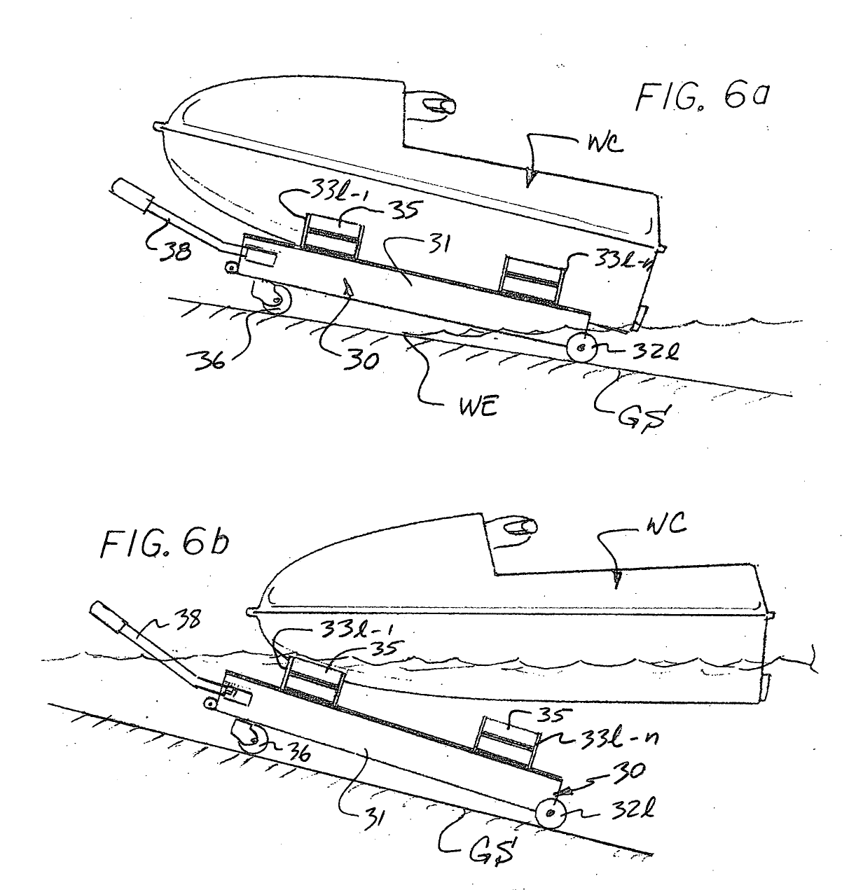

Once the dolly is fully released its connection to belt 16 is then disengaged so that it can be rolled down the launching ramp LR until the watercraft WC thereon floats off its cradle, as illustrated in FIGS. 5, 6a and 5b. To render this task even more convenient a guide arm 38 may be selectively secured to the dolly base 31 for use as a control arm in the course of translation of both the loaded and unloaded dolly. Of course, the recovery of the watercraft and its loading back onto the truck bed TB is simply a reverse of the sequence described above.

It will be appreciated that the foregoing combination is particularly useful in salt water settings with the corrosives associated therewith. Simply, the limited rolling travel of the dolly described herein eliminates all necessity for expensive bearing provisions and the maintenance associated therewith. Moreover, the unloading geometry herein described is particularly suited for use right at the water's edge WE, further limiting the necessity for elaborate rolling provisions.

Obviously many variations and modifications can be effected without departing from spirit of the teachings instantly disclosed. It is therefore intended that the scope of the invention be determined solely by the claims appended hereto.

1. In a carrier assembly mounted on a truck bed and conformed for articulation to urge by a spring from said bed to an inclined alignment at the rear edge of said bed a ramp included in said carrier assembly and conformed to support a rolling article thereon in the course of the movement of said article between the ground surface and said truck bed and a powered pulley for taking up and extending a belt, the improvement comprising:
a dolly defined by a base piece conformed for translating receipt on said ramp supporting a ribbed cradle conformed to receive and engage the hull of a personal watercraft, said base piece including rolling means for the translation thereof on said ramp and said ground surface; and
attachment means for selectively securing the free end of said belt to said dolly.

2. Apparatus according to claim 1 wherein:
said ramp includes a stop formed on the forward end thereof for limiting the forward translation of said base piece thereon.

3. Apparatus according to claim 2, further comprising:
said spring being operatively connected between said bed and said ramp to urge said ramp rearwardly beyond the rear edge of said bed upon the extension of said belt whereby the rearward movement of the combined center of gravity of said ramp, said dolly mounted thereon and said watercraft carried thereon effects a pivotal motion of said ramp to said inclined alignment.

4. Apparatus according to claim 3, further comprising:
an wheel assembly selectively engageable to said base piece upon the translation thereof out of said ramp.

5. Apparatus according to claim 4, further comprising:
a handle selectively engageable to said base piece for manually controlling the translation thereof on said ground surface.

6. In a carrier assembly mounted on a truck bed and conformed for articulation to urge by a spring from said bed to an inclined alignment at the rear edge of said bed a ramp included in said carrier assembly, said carrier assembly including a pivot recess included in said carrier assembly for providing a pivot for said ramp into said inclined alignment upon a predetermined translation thereof in the course of the movement of said article between the ground surface and said truck bed and a powered pulley for taking up and extending a belt, the improvement comprising:
a dolly defined by a base piece conformed for translating receipt on said ramp, a ribbed cradle mounted on said base piece and conformed to receive and engage the hull of a personal watercraft, rolling means mounted on the rear end of said base piece for supporting the translation thereof on said ramp and said ground surface and attachment means for selectively securing the free end of said belt to said dolly; and
said spring being connected between said truck bed and said ramp for urging said ramp rearwardly beyond the rear edge of said bed upon the extension of said belt whereby the rearward movement of the combined center of gravity of said ramp, said dolly mounted thereon and said watercraft carried thereon effects a pivotal motion of said ramp to said inclined alignment.

7. Apparatus according to claim 6 wherein:
said ramp includes a stop formed on the forward end thereof for limiting the forward translation of said base piece thereon.

8. Apparatus according to claim 7, further comprising:
an wheel assembly selectively engageable to said base piece upon the translation thereof out of said ramp.

9. Apparatus according to claim 8, further comprising:
a handle selectively engageable to said base piece for manually controlling the translation thereof on said ground surface.

10. Apparatus according to claim 7, wherein:
said cage includes a plurality of ribs orthogonally cantilevered from each of the lateral sides of said base piece and a plurality of rollers selectively mounted between adjacent ones of said ribs.

11. Apparatus according to claim 10, further comprising:
an wheel assembly selectively engageable to said base piece upon the translation thereof out of said ramp and a handle selectively engageable to said base piece for manually controlling the translation thereof on said ground surface.

12. In a carrier assembly mounted on a truck bed and conformed to be urged by a spring to extend beyond the edge of said bed to an inclined alignment a ramp to support a rolling article thereon in the course of translation thereof between the ground surface and said truck bed in response to the operation of a powered pulley] adapted for taking up and extending a belt, the improvement comprising:
a dolly defined by a base piece conformed for translating receipt on said ramp, a ribbed cradle mounted on said base piece and conformed to receive and engage the hull of a personal watercraft, rolling means mounted on the rear end of said base piece for supporting the translation thereof on said ramp and said ground surface and attachment means for selectively securing the free end of said belt to said dolly; and
said spring is operatively connected between said bed and said ramp for urging said ramp rearwardly beyond the rear edge of said bed upon the extension of said belt whereby the rearward movement of the combined center of gravity of said ramp, said dolly mounted thereon and said watercraft carried thereon effects a pivotal motion of said ramp to said inclined alignment.

13. Apparatus according to claim 12, wherein:
said cage includes a plurality of ribs orthogonally cantilevered from each of the lateral sides of said base piece and a plurality of rollers selectively mounted between adjacent ones of said ribs.

14. Apparatus according to claim 13, further comprising:
an wheel assembly selectively engageable to said base piece upon the translation thereof out of said ramp and a handle selectively engageable to said base piece for manually controlling the translation thereof on said ground surface.
